(19) United States
(12) Patent Application Publication
(10) Pub. No.: US 2012/0036002 A1
(43) Pub. Date: Feb. 9, 2012

(54) SYSTEM AND METHOD FOR A COMPUTER AUTOMATED CREATION AND DEPLOYMENT OF A COUPON

(76) Inventor: Karim Pirani, San Diego, CA (US)

(21) Appl. No.: 12/829,330

(22) Filed: Jul. 1, 2010

Related U.S. Application Data
(60) Provisional application No. 61/270,025, filed on Jul. 2, 2009.

(51) Int. Cl. G06Q 30/02

(52) U.S. Cl. 705/14.39

(57) ABSTRACT

A process, system and computer implemented method for making and deploying a coupon through a network to a client achieved by first entering coupon data into a plurality of fields by an advertiser; transmitting the coupon data through the network to a web server device where it is then transmitted to a application server device, the application server device transforms the data into the coupon which is stored in a database, where it is stored until retrieved. The application server device retrieves the coupon when parameters defined by the web server device, application server device, or advertiser computer are met. The coupon is then deployed to the web server device where it is then deployed through the network to the client.

### CROSS-REFERENCE TO RELATED APPLICATION

This application claims the benefit of priority to U.S. Provisional Application No. 61/270,025, entitled “SYSTEM AND METHOD FOR COMPUTER AUTOMATED CREATION AND DEPLOYMENT OF A COUPON” filed on Jul. 2, 2009, which is incorporated herein by reference in its entirety.

### BACKGROUND

The present invention is an automated process, system and method for generating and deploying coupons that a company places in the system to motivate consumers to use or purchase the company's products or services. Prior to this invention a merchant would have to make many decisions and spend substantial time to create a coupon. Furthermore coupons are generally stored as images taking substantially greater memory than storing fields within a database, or memory device.

### SUMMARY OF THE INVENTION

The present invention is an automated process, system and method for generating and deploying coupons. In one embodiment, the present invention generally relates to a method and automated system for making and deploying a coupon through a network.

One aspect of the invention is a system, including one or more processors, for collecting coupon data for use in generating coupons, having an advertiser computer, a host, and a requestor computer.

Another aspect of the invention is a system having a web server device, an application server device, and a database configured to store the coupon. Another aspect of the invention is a system having a means for uploading of an image.

Another aspect of the invention is a system having a means for previewing an image.

Another aspect of the invention is a system having a means for approving an image.

Another aspect of the invention is a system having an advertiser module that transmits with the web server device.

Another aspect of the invention is a system having a coupon template database.

Another aspect of the invention is a method for creating and deploying a coupon through a network to a client interface comprising: entering coupon data into an advertiser computer; transmitting the coupon data from the advertiser computer through the network to a web server device; transmitting the coupon data from the web server device to an application server device; transforming the coupon data into the coupon by the application server device; storing the coupon in a database; requesting a coupon by the requestor computer; deploying the coupon from the database to the application server device; deploying the coupon from the application server device to the web server device; and deploying the coupon from the web server device through the network to the requestor computer.

Another aspect of the invention is a method where the step of deploying the coupon to the requestor computer occurs within a geographical area defined by the advertiser computer.

Another aspect of the invention is a method where the advertiser computer transmits a coupon through the network to the web server device.

Another aspect of the invention is a method where the coupon is transmitted to a first client interface while another coupon is transmitted to a second client interface.

### BRIEF DESCRIPTION OF THE DRAWINGS

FIG. 1 illustrates a system for making and deploying a coupon through a network to a client.

FIG. 2 illustrates a more detailed embodiment of making and deploying a coupon through a network to a client by showing the screen flow for creating or editing the coupon.

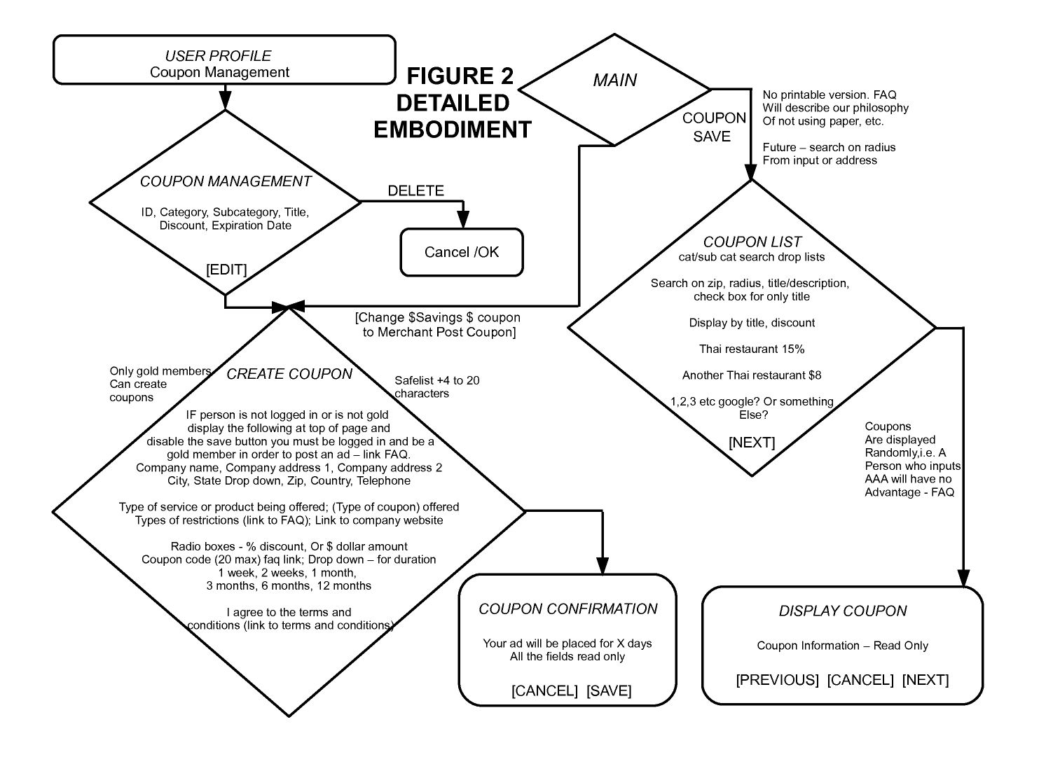

FIG. 3 illustrates a system for making and deploying a coupon through a network to a client where the display is detached from the client.

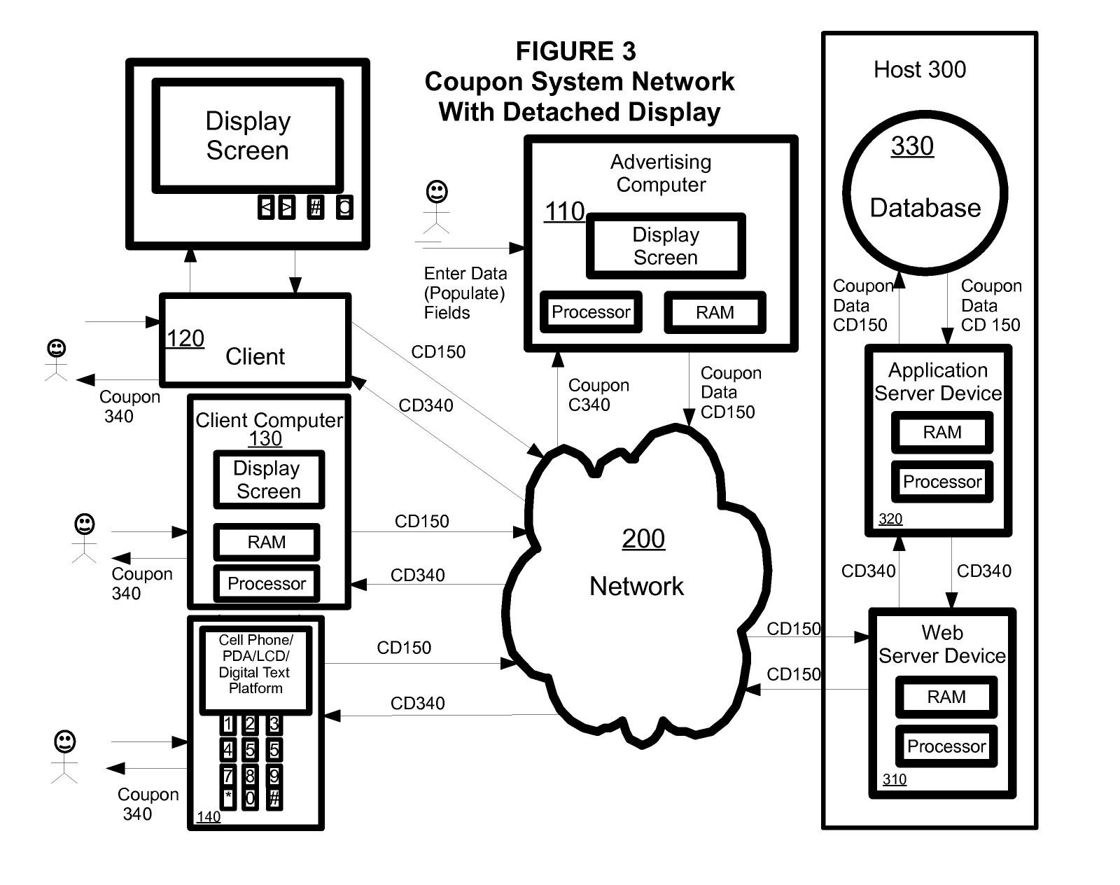

### DESCRIPTION OF THE INVENTION

To aid in understanding aspects of the invention described herein, some terms used in this description are defined below.

“Administrator” refers to a person or persons with administrator privileges to the application server device, the database, or web server device.

“Advertiser” refers to a company, person, or entity issuing a coupon related to a product or service.

“Browser” refers to an application that provides a user interface to the network, particularly if the network is the World Wide Web.

“Client” refers to consumer or end user, the person or entity utilizing a coupon to obtain a discount on a product or service.

“Coupon” refers to an image which may or may not be printed. The image depicts a product or service for which an advertising client wishes to stimulate purchase thereof. The coupon may offer a discount or other enticement to a (consumer) client.

“Display” refers to a monitor, LCD, or other visual means for viewing information. The displays may be part of the client or detached from the client such as a computer monitor.

“Field” refers to data within a single category that is either stored a database or used by an application server device, such as.

“Produce” refers to “produce an electronic image of a coupon that can printed or used in electronic format.”

“Producing” refers to “producing an electronic image of a coupon that can be printed or used in electronic format.” The electronic image can be a data packet, or file which is capable of conversion into Such as, but not limited to a JPEG, BMP, TIFF, or the like.

“Process or module” refers to a set of instructions implemented in software, firmware or hardware, including any type of programmed step undertaken by components of the system.

“Template” refers to a layout to allow the advertising client to choose how the coupon is to be displayed.

“Website” refers to one or more interrelated web page files and other files and programs on one or more web servers. The files and programs are accessible over a computer network, such as the Internet, by sending a hypertext transfer protocol (HTTP) request specifying a uniform resource locator (URL) that identifies the location of one of the web page files. The files and programs may be owned, managed or authorized by a single business entity or an individual. Such files and programs can include, for example, hypertext markup language (HTML) files, common gateway interface (CGI) files, and Java applications.

“Wireless Application Protocol” refers to a specification for a set of communication protocols to standardize the way that wireless devices, such as wireless phones and radio transceivers, are used for Internet access.

In the following detailed description, reference is made to the accompanying drawings which form a part hereof and in which is shown by way of illustration specific embodiments in which the invention may be practiced. These embodiments are described in sufficient detail to enable those skilled in the art to practice the invention, and it is to be understood that other embodiments may be utilized and that structural or logical changes may be made without departing from the scope of the present invention.

The following detailed description is, therefore, not to be taken in a limiting sense, and the scope of the present invention is defined by the appended claims.

As used herein, a computer, including one or more computers comprising a web server, may be any microprocessor- or processor-controlled device or system that permits access to a network, including terminal devices, such as personal computers, workstations, servers, clients, mini computers, main-frame computers, laptop computers, a network of individual computers, mobile computers, palm-top computers, hand-held computers, tablet computers, digital text platforms, cell phones, smartphones, set top boxes for a television, interactive televisions, interactive kiosks, personal digital assistants, portable electronic devices, interactive wireless communications devices, mobile browsers, or a combination thereof. The computers may further possess input devices such as a keyboard, mouse, touchpad, joystick, pen-input-pad, and output devices such as a computer screen and a printer.

These computers may be uni-processor or multi-processor machines.

Additionally, these computers include an addressable storage medium or computer accessible medium, such as random access memory (RAM), an electronically erasable programmable read-only memory (EEPROM), programmable read-only memory (PROM), erasable programmable read-only memory (EPROM), hard disks, floppy disks, laser disk players, digital video devices, compact disks, video tapes, audio tapes, magnetic recording tracks, electronic networks, and other techniques to transmit or store electronic content such as, by way of example, programs and data. In one embodiment, the computers are equipped with a network communication device, for example, without limitation, a network interface card, a cable modem, a wireless modem, a telephone modem, an Ethernet card, or any other network connection device suitable for connecting to a networked communication medium.

Wireless devices may implement browsers using the Wireless Application Protocol or other wireless modes.

Furthermore, the computers execute an appropriate operating system such as Linux, Unix, Microsoft® Windows®, Apple® MacOS®, and IBM® OS/2®. As is convention, the appropriate operating system includes a communications protocol implementation which handles all incoming and outgoing message traffic passed over a network. In other embodiments, while different computers may employ different operating systems, the operating system will continue to provide the appropriate communications protocols necessary to establish communication links with a network.

The computers may advantageously contain program logic, or other substrate configuration representing data and instructions, which cause the computer to operate in a specific and predefined manner as described herein. In one embodiment, the program logic may advantageously be implemented as one or more modules. Each of the modules may comprise various sub-routines, procedures, definitional statements and macros. Each of the modules is typically separately compiled and linked into a single executable program. Therefore, the description of each of the modules in this disclosure is used for convenience to describe the functionality of the preferred system. Thus, the processes that are performed by each of the modules may be arbitrarily redistributed to one of the other modules, combined together in a single module, or made available in, for example, a shareable dynamic link library.

The modules may be configured to reside on the addressable storage medium and configured to execute on one or more processors. The modules can be, for example, without limitation, software or hardware components which perform certain tasks. Thus, a module may include, by way of example, components, such as, software components, object-oriented software components, class components and task components, processes, functions, attributes, procedures, subroutines, segments of program code, drivers, firmware, microcode, Java byte codes, circuitry, data, databases, data structures, tables, arrays, and variables.

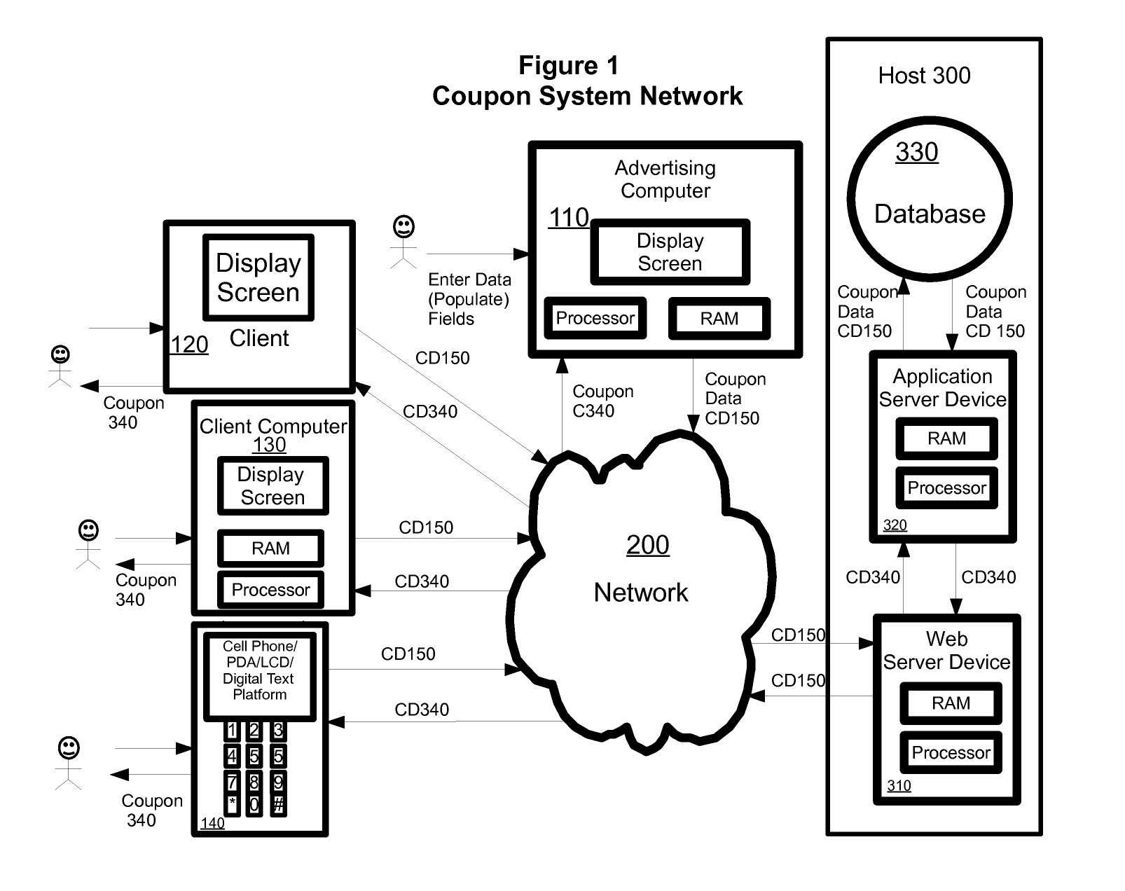

The present invention provides for a method and system for collecting coupon data 150 for use in creating and deploying a coupon 340 through a network 200. As shown in FIG. 1, the system is composed of a host 300 interfaced through, for example, without limitation, a network 200 to at least one advertiser computer 110 and at least one client computer 120.

The network 200 is any type of communication network 200 as is commonly known by one skilled in the field and as was described previously. The network 200 may be a Local Area Network (LAN), a Wide Area Network (WAN), a public network such as the Internet, or a wireless network or any combination of such networks. The network 200 interconnection between the host 300 and the client may be accomplished using hard wired lines or through wireless Radio Frequency (RF) links. The various embodiments of the invention are not limited by the interconnection method used in the network 200 or the physical location of the host 300 or clients.

The advertiser computer 110 receives input data from the advertiser and provides output data to the host 300. The advertiser may be a company that wishes to offer a coupon 340 for a product or service to a consumer. The advertiser inputs the coupon data 150 into the advertiser computer 110 by entering coupon data 150 into a field of an advertiser module. The coupon data 150 is the information the advertiser desires to associate with or incorporate into the coupon 340. The coupon data 150 can be, for example, without limitation, name of advertiser, type of coupon, company logo, company motto, type of service, type of product, category, sub-category, description of offering, detailed restrictions of coupon, discount percentage, discount amount, coupon code, start date, expiration date, duration of coupon, template identifier, or the like. In another embodiment, the system provides for a database of coupon templates that can be incorporated into the coupon 340. The coupon template database is a library of files in the electronic form of TIFF, BMP, JPEG, or the like, that allows the advertiser to choose a desired template.

The advertiser computer 110 also transmits the coupon data 150 to the web server device 310 through the network 200. The advertiser computer 110 can interface with the host 300 through the network 200 using an interface module, for example, without limitation, a browser. The interface module implements the communication formatting and protocol necessary for communication over the network 200.

In one embodiment, the advertiser can upload an image of a coupon 340 into the advertiser module. In another embodiment, the advertiser can upload an image of a logo into the advertiser module to be embedded into a template. The advertiser module transmits the image or logo to the host 300 to be stored in the database 330.

The advertiser computer 110 implements an advertiser interface to receive input from the advertiser through, for example, without limitation, a keyboard or a mouse and to provide output to the advertiser in the form of coupon data 150. The output may be in the form of an operating window displayed on a monitor that provides the advertiser with an image display and corresponding control menus that can be accessed using a keyboard, a mouse or other user interface devices. The output may display the coupon 340 by a category or subcategory. The advertiser interface allow the advertiser to edit or delete a coupon 340 that is stored on the database 330.

In the preferred embodiment, upon the input of the coupon data 150 into the advertiser computer 110, the advertiser module allows the advertiser to preview and approve the incorporation of the coupon data 150 into the selected template, as it would appear to a client. Once the coupon 340 is approved by the advertiser, the coupon data 150 is transmitted to the host 300 to be stored. In one embodiment, the advertiser module participates in transmitting the coupon data 150 to the host 300.

Once the coupon data 150 has been entered into the advertiser module, the advertiser computer 110 transmits the coupon data 150 to the host 300 through the network 200. The host 300 receives the transmitted coupon data 150 from the advertiser computer 110, inputs the coupon data 150 into a coupon 340, and stores the coupon 340 to be deployed at a later time period thereby generating dynamic content. The host 300 can be a computer including one or more processes or modules that may interface with various hardware devices on the computer. In the preferred embodiment, the host 300 can have a web server device 310, an application server device 320, and a database 330. The web server device 310 is used to configure the host 300 as a web server device 310 thereby allowing the host 300 to receive the coupon data 150 from the advertiser computer 110. In one embodiment, the web server device 310 can interface the host 300 with a plurality of advertiser computer 110s and a plurality of client computers 120, 130, 140 through the network 200. The web server device 310 then transmits the coupon data 150 to the application server device 320. The application server device 320 is a module that receives the coupon data 150 from the web server device 310. The application server device 320 then transforms the coupon data 150 into a coupon 340 and stores the coupon 340 in the database 330 as static content, thus providing a record of the coupon 340 and allowing for the quick deployment by the application server device 320.

Upon storing the coupon 340, a host 300 administrator inputs the advertiser's identifying information into the application server device 320. The host 300 administrator then performs a background check of the advertiser. Upon proper verification, the advertiser is entered into the system thereby allowing said advertiser to activate their account.

Once the advertiser's account is activated, the advertiser can generate coupons 340 to be distributed by the advertiser. The advertiser can obtain a coupon 340 in the following manner. The advertiser computer 110 receives a coupon 340 request from the advertiser and transmits the coupon 340 request to the web server device 310 through the network 200. The web server device 310 transmits the request to the application server device 320 which deploys the coupon 340 from the database 330 to the web server device 310. The web server device 310 deploys the coupon 340 to the advertiser computer 110 through the network 200 and the advertiser receives the coupon 340 from the advertiser computer 110.

Coupons 340 can be physical coupon made of paper or an electronic coupon that can be downloaded to a personal computer, a cell phone, a personal data assistant, liquid crystal display screen, a digital text platform, a portable electronic device, or the like. The host 300 may also incorporate other modules not directly allocated to establishing communications to the client. For example, an IP PROC may be included within the host 300 when the host 300 is configured to operate over, for example, the Internet. The IP PROC is used to communicate the host's 300 Internet Protocol (IP) address. The IP PROC is particularly useful when the host's 300 IP address is dynamic and changes each time the host 300 initially connects to the network 200. In one embodiment, the IP PROC at the host 300 works in conjunction with a Domain Name System (DNS) host 300 server connected to the network 200 to allow clients to locate and establish a connection to the host 300 even though the host 300 has a dynamic IP address.

The host 300 implements a host 300 interface to receive input from an administrator through, for example, without limitation, a keyboard or a mouse and to provide output to the administrator in the form of coupon data 150. The output may be in the form of an operating window displayed on a monitor that provides the user with an image display and corresponding control menus that can be accessed using a keyboard, a mouse or other user interface devices. The host 300 interface allows the administrator to edit or delete any coupon 340 in the system.

In one embodiment, the host 300 is implemented on a personal computer. The host 300 process is stored as a collection of instructions that are stored in the personal computer. The instructions may be stored in memory, such as Read-Only Memory (ROM) or Random Access Memory (RAM), a hard disk, a floppy disk to be used in conjunction with a floppy disk drive, or a combination of storage devices. The instructions are executed in the Central Processing Unit (CPU) and are accessed through a bus coupling the storage devices to the CPU. The bus can include at least one address bus and one data bus, although multiple buses may also be used. Host 300 input is coupled to the personal computer through a keyboard, a mouse or other user input device. Images are displayed to the user through a monitor that receives signals from a video controller.

The connection from the host 300 to the network 200 may be made, for example, without limitation, using a network 200 interface card, a cable modem, a wireless modem, a telephone modem, an Ethernet card, or any other network 200 connection device suitable for connecting to a networked communication medium.

The client computer 120 can interface with the host 300 through the network 200 using an interface module, for example, without limitation, a browser. The browser implements the communication formatting and protocol necessary for communication over the network 200. The client computer 120 can have one or more process or modules. The client computer 120 is typically capable of two-way communications with the host 300. The two-way link allows the client computer 120 to send information as well as receive information. A TCP/IP socket operating system module running on the host 300 allows the host 300 to establish sockets for communication between the host 300 and the client computer 120.

The client can obtain a coupon 340 in the following manner. The client computer 120 receives a coupon 340 request from the client and transmits the coupon 340 request to the web server device 310 through the network 200. The web server device 310 transmits the request to the application server device 320 which deploys the coupon 340 from the database 330 to the web server device 310 when data parameters defined by the advertiser computer 110, web server device 310, or the application server device 320 are met. The web server device 310 deploys the coupon 340 to the client computer 120 through the network 200 and the client receives the coupon 340 from the client computer 120.

The client computer 120 implements a client interface to receive input from the client and send output to the client. The input of the client interface may be, for example, without limitation, in the form of a keyboard, a mouse, or other user interface devices. The output of the client interface may be for example, without limitation, in the form of an operating window displayed on a monitor that provides the advertiser with an image display and corresponding control menus that can be accessed using a keyboard, a mouse, or other user interface devices.

The client computer 120 can be a remote hardware system that is also connected to the network 200. The client may be configured to run a Java-enabled browser. The browser allows the user to look at and interact with the information provided on the World Wide Web. A variety of commercially available browsers are available for computers. Similarly, compact browsers are available for use in portable devices such as wireless phones and personal digital assistants. The features available in the browser may be limited by the available processing, memory, and display capabilities of the hardware device running the browser.

The foregoing has described the principles, embodiments, and modes of operation of the present invention. However, the invention should not be construed as being limited to the particular embodiments described above, as they should be regarded as being illustrative and not as restrictive. It should be appreciated that variations may be made in those embodiments by those skilled in the art without departing from the scope of the present invention.

Modifications and variations of the present invention are possible in light of the above teachings. It is therefore to be understood that the invention may be practiced otherwise than as specifically described herein.

We claim:

1. A system, including one or more processors, for collecting coupon data for use in generating coupons, comprising:
an advertiser computer configured such that an advertiser thereon can access a network, wherein the advertiser computer is configured to receive coupon data from the advertiser and transmit coupon data to a host;
the host configured to receive the coupon data, transform the coupon data to a coupon, store the coupon, receive a coupon request, and deploy the coupon to a requestor computer;
the requestor computer configured such that a client thereon can access a network, wherein the requestor computer is configured to receive a coupon request from a requestor, transmit a coupon request to the web server device, receive the coupon from the web server device, and provide the coupon to the requestor.

2. A system of claim 1 wherein said host comprises:
a web server device configured to receive the coupon data from the advertiser computer, transmit the coupon data to the application server device, receive a coupon request from a requestor computer, receive the coupon from the application server device, and deploy the coupon to the requestor computer;
an application server device configured to receive the coupon data from the web server device and transform the coupon data into the coupon, store the coupon in a database, and deploy the coupon to web server device; and
a database configured to store the coupon.

3. A system of claim 1 wherein said advertising computer comprises a means for uploading of an image.

4. A system of claim 1 wherein said advertising computer comprises a means for previewing an image.

5. A system of claim 1 wherein said advertising computer comprises a means for approving an image.

6. A system of claim 1 wherein said advertising computer comprises an advertiser module that transmits with the web server device.

7. A system of claim 1 wherein said requestor is a client or the advertiser.

8. A system of claim 7 wherein said requestor computer is a client computer or the advertiser computer.

9. A system of claim 8 wherein said client computer comprises a client module that transmits with the web server device.

10. A system of claim 1 further comprising a coupon template database.

11. A computer implemented method for creating and deploying a coupon through a network to a client interface comprising:
entering coupon data into an advertiser computer;
transmitting the coupon data from the advertiser computer through the network to a web server device;
transmitting the coupon data from the web server device to an application server device;
transforming the coupon data into the coupon by the application server device;
storing the coupon in a database;
requesting a coupon by the requestor computer;
deploying the coupon from the database to the application server device;
deploying the coupon from the application server device to the web server device; and
deploying the coupon from the web server device through the network to the requestor computer.

12. The method of claim 11 further comprising step for previewing an image on the advertiser computer.

13. The method of claim 11 further comprising step for approving an image on the advertiser computer.

14. The method of claim 1 wherein the coupon data is entered by an advertiser.

15. The method of claim 1 wherein the coupon data is transformed into a coupon using a desired template.

16. The method of claim 1 wherein the coupon data are selected from the group consisting of type of service, type of product, description of offering, detailed restrictions of coupon, discount percentage, discount amount, coupon code, start date, expiration date, duration, choice of template, or any combinations thereof.

17. The method of claim 1 wherein the step of deploying the coupon to the requestor computer occurs within a geographical area defined by the advertiser computer.

18. The method of claim 1 wherein the advertiser computer transmits a coupon through the network to the web server device.

19. The method of claim 1 wherein the advertiser computer transmits a logo through the network to the web server device, wherein said logo is embedded on a template.

20. The method of claim 1 wherein the coupon is transmitted to a first client interface while another coupon is transmitted to a second client interface.
